(19) United States
(12) Patent Application Publication
(10) Pub. No.: US 2025/0335407 A1
(43) Pub. Date: Oct. 30, 2025

(54) SYSTEM, METHOD, AND APPARATUS FOR AI-POWERED INSIGHT EXTRACTION FROM VIDEO CONTENT

(71) Applicant: Transformation Continuum, Chicago, IL (US)

(72) Inventors: Joseph Evans Onisick, Sheridan, WY (US); Reuven Cohen, Oakville (CA)

(21) Appl. No.: 19/190,352

(22) Filed: Apr. 25, 2025

Related U.S. Application Data
(60) Provisional application No. 63/638,656, filed on Apr. 25, 2024.

(51) Int. Cl. G06F 16/215

(52) U.S. Cl. CPC G06F 16/215

(57) ABSTRACT

Provided herein is a system for providing a database engine. The system includes a data ingestion layer; a data processing and enrichment layer; and a knowledge serving layer, and is configured to provide an automated source of truth.

### CROSS-REFERENCE TO RELATED APPLICATIONS

The present application claims priority under 35 U.S.C. § 119 (e) to U.S. Provisional Patent Application No. 63/638,656, filed Apr. 25, 2024, which application is incorporated herein by reference in its entirety.

### BACKGROUND OF THE INVENTION

When dealing with large volumes of data, companies often millions of data artifacts scattered across various platforms, both current and legacy. As a result, these companies, including tech companies, typically have problems finding accurate, up-to-date, data, even as it relates to their own products.

Accordingly, there remains a need in the art for systems and methods for data ingest, analysis, and organization. The present invention meets this need.

### SUMMARY

In one aspect, a system for providing a database engine includes a data ingestion layer; a data processing and enrichment layer; and a knowledge serving layer; wherein the system is configured to provide an automated source of truth. In some embodiments, the system is configured to ingest and filter data from one or more data sources and automatically validate, catalogue, index, tag, assign a confidence score along with document links, or a combination thereof. In some embodiments, the data includes unstructured data.

In some embodiments, the data ingestion layer includes at least one connector coupling the system to the one or more data sources and a data repository.

In some embodiments, the data processing and enrichment layer comprises at least one of a de-duplication engine; a conflict resolution module; a trustworthiness scoring module; and a tagging and indexing service.

In some embodiments, the de-duplication engine comprises a machine-learning algorithm. In some embodiments, the machine-learning algorithm is configured to de-duplicate the data at a factoid level. In some embodiments, the de-duplication engine is configured to combine the machine-learning algorithm with at least one other de-duplication approach.

In some embodiments, the conflict resolution module is configured to assess conflicting information and determine a most likely truth. In some embodiments, the conflict resolution module comprises a machine learning algorithm. In some embodiments, the machine learning algorithm is trained to determine the most likely truth through at least one of analyzing source credibility, analyzing source recency, and corroborating across multiple sources. In some embodiments, the trustworthiness scoring module is configured to assign a confidence score to the most likely truth. In some embodiments, the confidence score id based upon at least one of source reliability, data age, level of agreement across sources, and/or the outcome of the conflict resolution process.

In some embodiments, the tagging and indexing service is configured to automatically extract metadata from the data. In some embodiments, the tagging and indexing service extracts the metadata using natural language processing.

In some embodiments, the knowledge serving layer comprises a search application programming interface (API), the API configured to provide an interface for querying indexed data from the data processing and enrichment layer. In some embodiments, the search API is configured to provide search results with at least one of an identified “truth,” a confidence score, and a link to original source artifacts in the data. In some embodiments, the knowledge serving layer further comprises a training interface configured to enable review of low-confidence data.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 provides an example overview of a system that can be used to practice embodiments of the present disclosure.

FIG. 2 provides an example computing entity in accordance with some embodiments discussed herein.

FIG. 3 provides an example external computing entity in accordance with some embodiments discussed herein.

### DETAILED DESCRIPTION OF THE INVENTION

### Definitions

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

The terms “proximal” and “distal” can refer to the position of a portion of a device relative to the remainder of the device or the opposing end as it appears in the drawing. The proximal end can be used to refer to the end manipulated by the user. The distal end can be used to refer to the end of the device that is inserted and advanced and is furthest away from the user. As will be appreciated by those skilled in the art, the use of proximal and distal could change in another context, e.g., the anatomical context in which proximal and distal use the patient as reference, or where the entry point is distal from the user.

The terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION

Provided herein are systems configured to enable automated data engines. In some embodiments, the system is configured to provide an automated source of truth. For example, in some embodiments, the system includes a data ingestion layer, a data processing and enrichment layer, and a knowledge serving layer. In some such embodiments, the system ingests and filters unstructured and/or structured data from one or more data sources, and automatically validates, catalogues, indexes, tags, and/or assigns a confidence score along with document links.

Unstructured data sources include, but are not limited to, data storage elements (e.g., cloud storage services, such as Google Drive), email servers, chat programs/platforms, collaborative editing services (e.g., Confluence, other wikis), or any other suitable unstructured data source. Structured data sources include, but are not limited to, any repository that organizes data in a clear, predefined format. For example, in some embodiments, the structured data source includes a structured query language (SQL) database.

The data ingestion layer includes any suitable structure for gathering and/or storing data. In some embodiments, for example, the data ingestion layer includes one or more connectors and a data repository. The connectors can be pre-built (e.g., Google Cloud Integration Connectors) and/or custom (e.g., Google Cloud Functions, Cloud Run) connectors to any suitable data source(s) (e.g., structured or unstructured). In some embodiments, the connectors couple the system to one or more data sources using application programming interfaces (APIs) or other suitable integration methods. The data repository includes any suitable repository for storing raw, unstructured data in its native format, such as, but not limited to, a cloud storage service (e.g., Google Cloud Storage).

The data processing and enrichment layer includes any suitable structure for analyzing disparate data sources, correlating related data sources, deduplicating redundant data elements, deconflicting conflicted data elements, and/or storing processed data elements along with a confidence score of the elements validity. In some embodiments, the data processing and enrichment layer includes a de-duplication engine configured to identify and merge de-duplication elements. For example, in some embodiments, the de-duplication engine utilizes a machine-learning model or other artificial intelligence to identify and merge the de-duplication elements. Additionally or alternatively, in some embodiments, the de-duplication engine combines the machine-learning model or other artificial intelligence with traditional methods (e.g., hashing, semantic similarity analysis using embeddings). The machine-learning model can be pre-trained or custom-trained. The custom-trained models can be trained using any suitable training method, such as, but not limited to, natural language API, text similarity, AutoML, any other suitable training method, and/or combinations thereof.

In contrast to existing methods, where de-duplication is applied to data blocks, data files, and the like, the de-duplication engine described herein is configured to de-duplicate at a factoid level (i.e., the de-duplication elements are factoids). In some such embodiments, the individual factoids are not in identical form, but instead refer to the same fact/element. As an example, when one factoid includes “Lincoln was elected in 1860” and another includes “the president who won the election of 1860 was Abraham Lincoln,” the de-duplication engine recognizes a duplicate factoid and stores a single data element (e.g., “Lincoln elected 1860”). In some embodiments, the single data element is stored with indexing hash for later recall.

In some embodiments, the data processing and enrichment layer also includes a conflict resolution module configured to assess conflicting information and determine the most likely “truth.” For example, in some embodiments, the conflict resolution model includes AI-powered techniques for assessing conflicting information and determining the most likely truth. Suitable AI-powered techniques include, but are not limited to, natural language understanding to analyze content, machine learning models trained on historical conflict resolution data, and/or any other suitable AI-powered technique. In some embodiments, the A I-powered technique for determining the most likely truth includes analyzing source credibility, recency, and corroboration across multiple sources.

In some embodiments, the data processing and enrichment layer further includes a trustworthiness scoring module. Following deduplication and/or conflict resolution, the trustworthiness scoring module assigns a confidence score to the “truth” data. The confidence score can be based upon any suitable factors, such as, but not limited to, source reliability, data age, level of agreement across sources, and/or the outcome of the conflict resolution process. In some embodiments, the confidence score is determined using statistical methods and/or machine learning models.

Additionally or alternatively, in some embodiments, the data processing and enrichment layer includes a tagging and indexing service. In some embodiments, the tagging and indexing service includes natural language processing (NLP) configured to automatically extract relevant information from the data. The NLP includes any suitable NLP for extracting the relevant information. As will be appreciated by those skilled in the art, the relevant information depends upon the data and the particular tagging/indexing desired. For example, in some embodiments, the relevant information includes keywords, entities, and/of topics. Following extraction, the relevant information, or metadata, along with the full text, is indexed for rapid retrieval. The metadata can be indexed in any suitable manner, such as, but not limited to, using a search engine (e.g., Google Cloud Search or Elasticsearch). The metadata, and configurations, can be stored in any suitable database or storage element, such as, but not limited to, Google Cloud Firestore (NoSQL) or Google Cloud SQL (PostgreSQL or MySQL) for storing metadata about ingested data, confidence scores, tags, and platform configurations.

The knowledge serving layer includes a search API configured to provide an interface for querying the indexed data from the data processing and enrichment layer. The interface can be configured for any suitable user and/or other system to query the indexed data. In some embodiments, search results are provided with the identified “truth,” its confidence score, and links back to the original source artifacts in the data lake/repository. Additionally or alternatively, in some embodiments, the knowledge serving layer includes a training interface configured to enable review (e.g., by a subject matter expert) of low-confidence “truth” data. In some embodiments, a threshold for the low-confidence “truth” data is user controlled and can be set to a desired confidence level (e.g., if a user sets the threshold for low-confidence at 70%, the system flags anything with a confidence score below 70%). The threshold for the low-confidence “truth” data includes any desired threshold appropriate for the type of data. In some embodiments, the low-confidence data is flagged for review by an appropriate subject matter expert and/or moved into a review pool. In some embodiments, the review includes providing feedback, correcting inaccuracies, and/or labeling data to further train the deduplication and/or conflict resolution models. The training interface can be provided in any suitable platform, such as, but not limited to, a web-based interfaces.

In some embodiments, the system includes one or more additional modules based upon a desired end-use. For example, in some embodiments, the system includes an AI troubleshooting assistant. In such embodiments, the AI troubleshooting assistant utilizes the source of truth architecture to provide guided self-service troubleshooting with advanced correlation capability. In another example, the system include a bespoke adoption guide generator configured to save customers hours of config guide time by providing step-by-step deployment guides tailored to their unique implementation and integrations. In a further example, the system includes a deal validator. In such embodiments, the deal validator is configured to ensure that a Bill of Materials (BOM) isn't missing anything required for success. Where multiple components, or SK Us can fulfill the same role, recommend the highest margin/rebate/etc. option.

As a result of the modular architecture, the system described herein can be readily adapted to any suitable application, including any application where automated data ingestion, validation, and indexing can be employed. Such applications include, but are not limited to, sales, search services, or any other suitable application. For example, in some embodiments, the system described herein is configured to ingest and filter unstructured and structured data from customer relationship databases (CRM s), product documentation, sales documentation, sales operations, etc. Additionally or alternatively, in some embodiments, the unstructured data includes video files. This data is automatically validated, catalogued, indexed, tagged, and assigned a confidence score along with source document links. The result is an automated Source of Truth (SoT) for product, sales, and technical information key to sales cycle success.

The system described herein can be implemented on any suitable computer system, architecture, or program. Therefore, although various embodiments are discussed below, as will be understood by those skilled in the art, the disclosure is not so limited and includes any other suitable computing platform capable of implementing the system described herein.

### 1. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJGRAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2SDRAM), double data rate type three synchronous dynamic random access memory (DDR3SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example System Framework

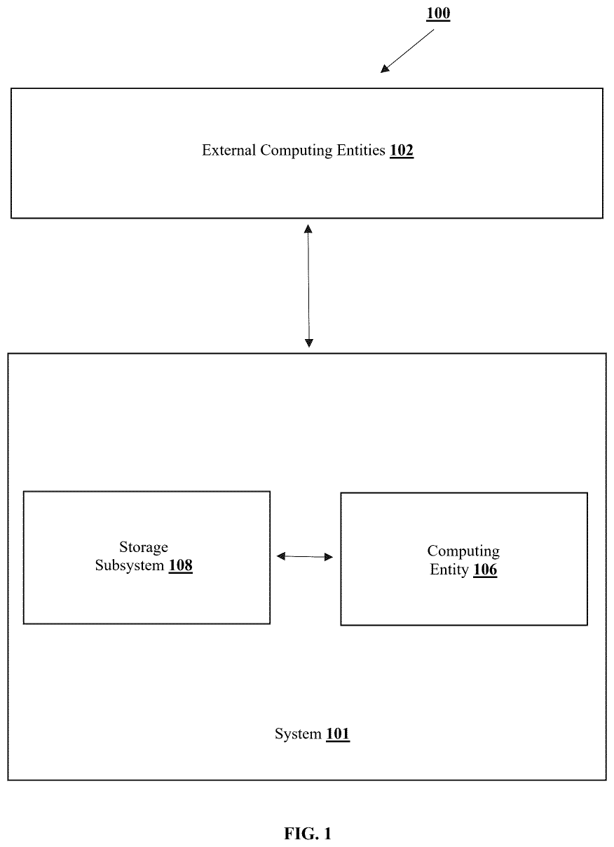

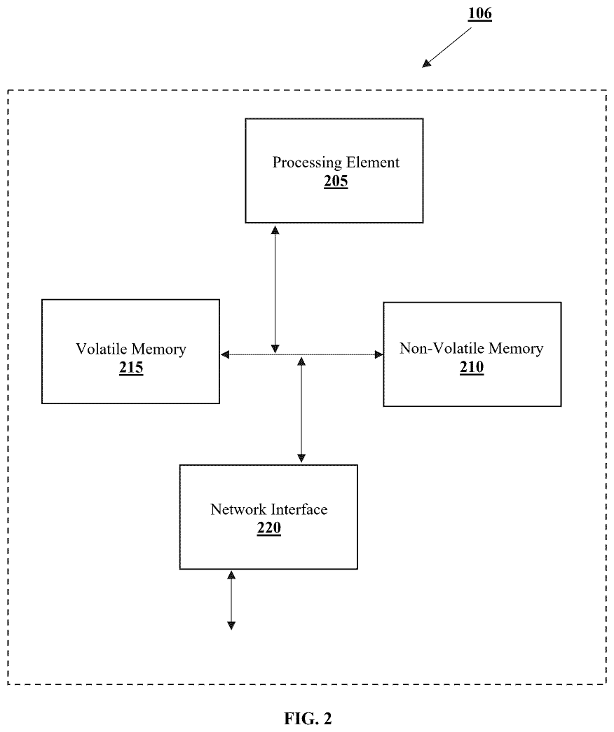

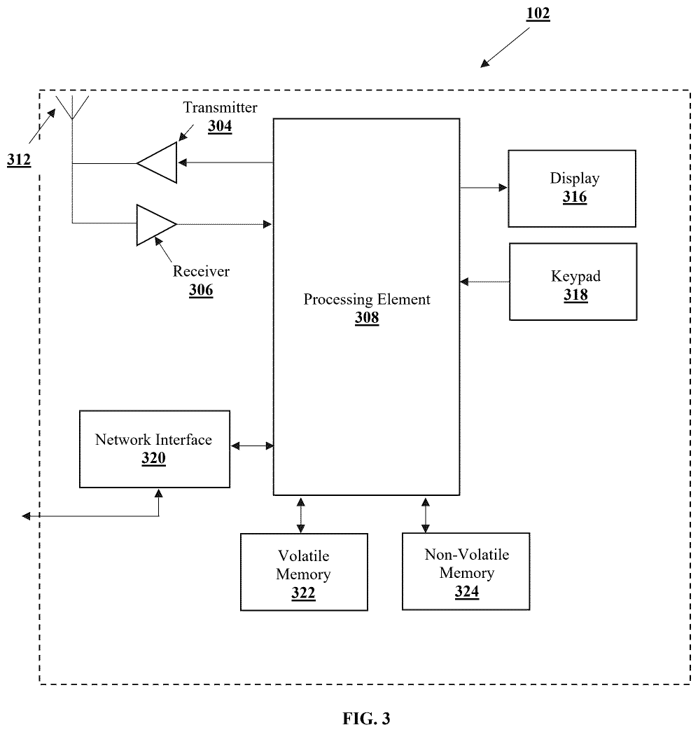

FIG. 1 provides an example overview of a system 100 that can be used to practice embodiments of the present disclosure. The system 100 includes a system 101 comprising a computing entity 106. The system 101 may communicate with one or more external computing entities 102A-N using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (e.g., network routers, and/or the like).

The system 100 includes a storage subsystem 108 configured to store at least a portion of the data utilized by the system 101. The computing entity 106 may be in communication with the external computing entities 102A-N.

The storage subsystem 108 may be configured to store the model definition data store and the training data store for one or more machine learning models. The computing entity 106 may be configured to receive requests and/or data from at least one of the external computing entities 102A-N, process the requests and/or data to generate outputs, and provide the outputs to at least one of the external computing entities 102A-N. In some embodiments, the external computing entity 102A, for example, may periodically update/provide raw and/or processed input data to the system 101. The external computing entities 102A-N may further generate user interface data (e.g., one or more data objects) corresponding to the outputs and may provide (e.g., transmit, send, and/or the like) the user interface data corresponding with the outputs for presentation to the external computing entity 102A (e.g., to an end-user).

The storage subsystem 108 may be configured to store at least a portion of the data utilized by the computing entity 106 to perform one or more steps/operations and/or tasks described herein. The storage subsystem 108 may be configured to store at least a portion of operational data and/or operational configuration data including operational instructions and parameters utilized by the computing entity 106 to perform the one or more steps/operations described herein. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The computing entity 106 can include an analysis engine and/or a training engine. The analysis engine may be configured to perform one or more data analysis techniques. The training engine may be configured to train the analysis engine in accordance with the data store stored in the storage subsystem 108.

### Example Computing Entity

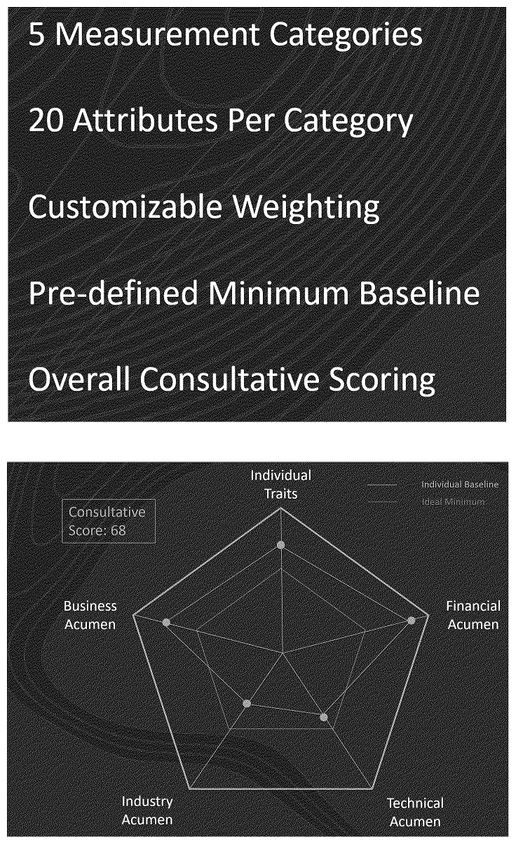

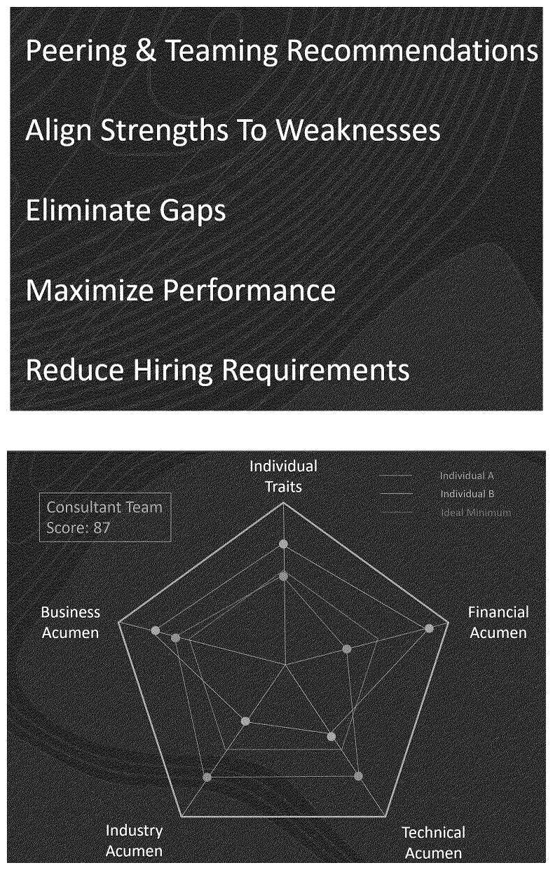

FIG. 2 provides an example computing entity 106 in accordance with some embodiments discussed herein. In general, the terms computing entity, computer, entity, device, system, and/or similar words used herein interchangeably may refer to, for example, one or more computers, computing entities, desktops, mobile phones, tablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes can be performed on data, content, information, and/or similar terms used herein interchangeably.

The computing entity 106 may include a network interface 220 for communicating with various computing entities, such as by communicating data, content, information, and/or similar terms used herein interchangeably that can be transmitted, received, operated on, processed, displayed, stored, and/or the like.

In one embodiment, the computing entity 106 may include or be in communication with a processing element 205 (also referred to as processors, processing circuitry, and/or similar terms used herein interchangeably) that communicate with other elements within the computing entity 106 via a bus, for example. As will be understood, the processing element 205 may be embodied in a number of different ways including, for example, as at least one processor/processing apparatus, one or more processors/processing apparatuses, and/or the like.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in one or more memory elements including, for example, one or more volatile memories 215 and/or non-volatile memories 210. As such, whether configured by hardware or computer program products, or by a combination thereof, the processing element 205 may be capable of performing steps or operations according to embodiments of the present disclosure when configured accordingly. The processing element 205, for example in combination with the one or more volatile memories 215 and/or or non-volatile memories 210, may be capable of implementing one or more computer-implemented methods described herein. In some implementations, the computing entity 106 can include a computing apparatus, the processing element 205 can include at least one processor of the computing apparatus, and the one or more volatile memories 215 and/or non-volatile memories 210 can include at least one memory including program code. The at least one memory and the program code can be configured to, upon execution by the at least one processor, cause the computing apparatus to perform one or more steps/operations described herein.

The non-volatile memories 210 (also referred to as non-volatile storage, memory, memory storage, memory circuitry, media, and/or similar terms used herein interchangeably) may include at least one non-volatile memory device 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile memories 210 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The one or more volatile memories 215 (also referred to as volatile storage, memory, memory storage, memory circuitry, media, and/or similar terms used herein interchangeably) can include at least one volatile memory device, including but not limited to RAM, DRAM, SRAM, FPM DRAM, EDO DRAM, SDRAM, DDR SDRAM, DDR2SDRAM, DDR3SDRAM, RDRAM, TTRAM, T-RAM, Z-RAM, RIMM, DIMM, SIMM, VRAM, cache memory, register memory, and/or the like.

As will be recognized, the volatile memories 215 may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain embodiments of the operation of the computing entity 106 with the assistance of the processing element 205.

As indicated, in one embodiment, the computing entity 106 may also include the network interface 220 for communicating with various computing entities, such as by communicating data, content, information, and/or the like that can be transmitted, received, operated on, processed, displayed, stored, and/or the like. Such communication data may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 106 may be configured to communicate via wireless client communication networks using any of a variety of protocols, such as general packet radio service (GPRS), Universal Mobile Telecommunications System (UMTS), Code Division Multiple Access 2000 (CDMA 2000), CDMA 2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

### Example External Computing Entity

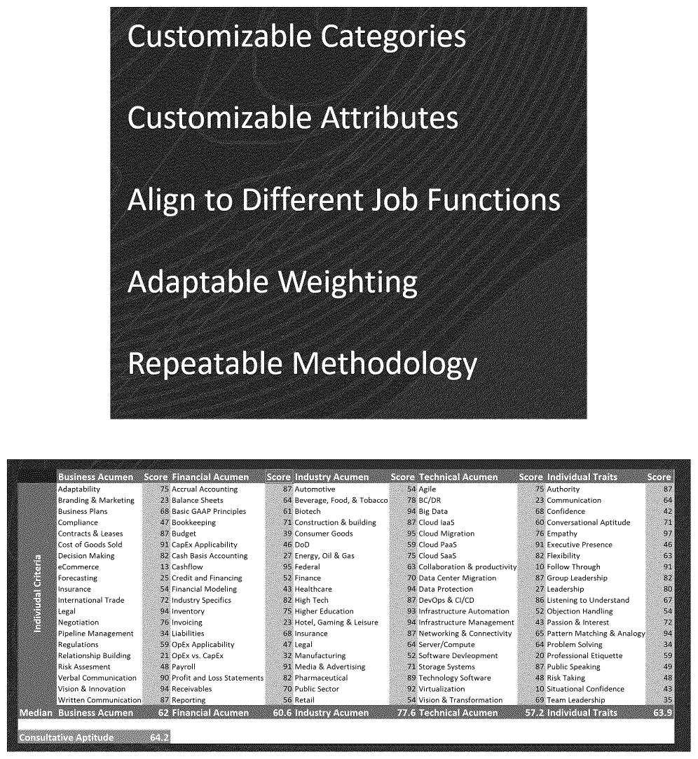

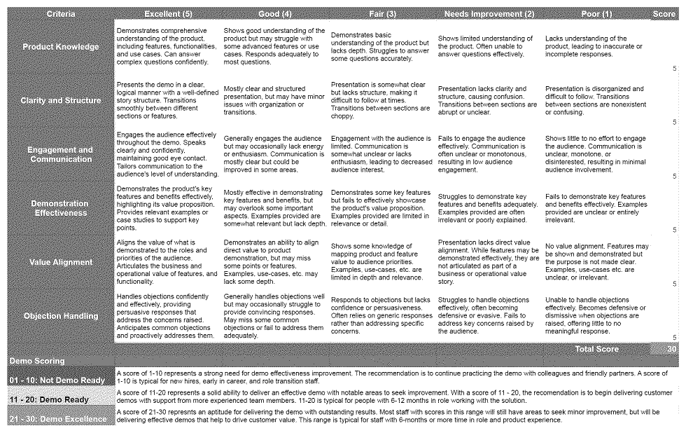

FIG. 3 provides an example external computing entity 102A in accordance with some embodiments discussed herein. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. The external computing entities 102A-N can be operated by various parties. As shown in FIG. 3, the external computing entity 102A can include an antenna 312, a transmitter 304 (e.g., radio), a receiver 306 (e.g., radio), and/or an external entity processing element 308 (e.g., CPLDs, microprocessors, multi-core processors, coprocessing entities, ASIPs, microcontrollers, and/or controllers) that provides signals to and receives signals from the transmitter 304 and the receiver 306, correspondingly. As will be understood, the external entity processing element 308 may be embodied in a number of different ways including, for example, as at least one processor/processing apparatus, one or more processors/processing apparatuses, and/or the like as described herein with reference to the processing element 205.

The signals provided to and received from the transmitter 304 and the receiver 306, correspondingly, may include signaling information/data in accordance with air interface standards of applicable wireless systems. In this regard, the external computing entity 102A may be capable of operating with one or more air interface standards, communication protocols, modulation types, and access types. M ore particularly, the external computing entity 102A may operate in accordance with any of a number of wireless communication standards and protocols, such as those described above with regard to the computing entity 106. In a particular embodiment, the external computing entity 102A may operate in accordance with multiple wireless communication standards and protocols, such as UMTS, CDMA 2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102A may operate in accordance with multiple wired communication standards and protocols, such as those described above with regard to the computing entity 106 via an external entity network interface 320.

Via these communication standards and protocols, the external computing entity 102A can communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102A can also download changes, add-ons, and updates, for instance, to its firmware, software (e.g., including executable instructions, applications, program modules), operating system, and/or the like.

According to one embodiment, the external computing entity 102A may include location determining embodiments, devices, modules, functionalities, and/or the like. For example, the external computing entity 102A may include outdoor positioning embodiments, such as a location module adapted to acquire, for example, latitude, longitude, altitude, geocode, course, direction, heading, speed, universal time (UTC), date, and/or various other information/data. In one embodiment, the location module can acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating a position of the external computing entity 102A in connection with a variety of other systems, including cellular towers, Wi-Fi access points, and/or the like. Similarly, the external computing entity 102A may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments can be used in a variety of settings to determine the location of someone or something to within inches or centimeters.

The external computing entity 102A may include a user interface 316 (e.g., a display, speaker, and/or the like) that can be coupled to the external entity processing element 308. In addition, or alternatively, the external computing entity 102A can include a user input interface 319 (e.g., keypad, touch screen, microphone, and/or the like) coupled to the external entity processing element 308).

For example, the user interface 316 may be a user application, browser, and/or similar words used herein interchangeably executing on and/or accessible via the external computing entity 102A to interact with and/or cause the display, announcement, and/or the like of information/data to a user. The user input interface 318 can comprise any of a number of input devices or interfaces allowing the external computing entity 102A to receive data including, as examples, a keypad (hard or soft), a touch display, voice/speech interfaces, motion interfaces, and/or any other input device. In embodiments including a keypad, the keypad can include (or cause display of) the conventional numeric (0-9) and related keys (#, *, and/or the like), and other keys used for operating the external computing entity 102A and may include a full set of alphabetic keys or set of keys that may be activated to provide a full set of alphanumeric keys. In addition to providing input, the user input interface 318 can be used, for example, to activate or deactivate certain functions, such as screen savers, sleep modes, and/or the like.

The external computing entity 102A can also include one or more external entity non-volatile memories 322 and/or one or more external entity volatile memories 324, which can be embedded within and/or may be removable from the external computing entity 102A. As will be understood, the external entity non-volatile memories 322 and/or the external entity volatile memories 324 may be embodied in a number of different ways including, for example, as described herein with reference to the non-volatile memories 210 and/or the external volatile memories 215.

Although the invention has been described in terms of exemplary embodiments, it is not limited thereto. Accordingly, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

The following examples further illustrate aspects of the present invention. However, they are in no way a limitation of the teachings or disclosure of the present invention as set forth herein.

### Examples

### Example 1—Proof-of-Concept

This Example describes a proof-of-concept approach demonstrating the feasibility of the system according to one or more of the embodiments disclosed herein.

First, initial data sources are selected. The initial data sources can include 2-3 (or more) representative unstructured data sources (e.g., a Google Drive folder with documents, a G-Chat channel). Next, basic ingestion is implemented by developing connectors to extract data from the selected sources and store it in a GCS bucket. The extracted data is then deduplicated, such as, for example, by implementing a basic deduplication mechanism using file hashing or comparing document metadata (name, size, creation date). Additionally or alternatively, a similarity API can be employed to identify semantically similar content.

After deduplication, the conflict resolution module assesses the extracted data for conflicting information and determines a most likely truth. A simplified version of this includes identifying a few examples of conflicting information within the ingested data (manually or programmatically), and implementing a simple rule-based approach to resolve these conflicts (e.g., prioritize the most recent information). Following conflict resolution, the data tagged and indexed using a Natural Language API to extract entities from a sample of documents and then using a search service to index these entities and the document content, enabling search functionality. The search results provided by the approach above include a direct link back to the original file in the GCS bucket.

To enable review, a web-based interface is provided where a subject matter expert can view the conflicting data examples and indicate the ‘truth’. This feedback can be manually analyzed to understand areas for improvement in the conflict resolution logic.

### Example 2—Customer Relationship Database Implementation

This Example describes implementation of the system described herein to intelligently assess performance and pairing of individual and teams based on extractions from video content.

### BACKGROUND

Following current macro trends, the call for more effective consulting sales teams will continue. These trends call for teams that can cover more territory, with fewer resources, while solving the underlying business problems that customers face. Technology adoption will continue to increase, requiring more well-trained and properly paired sales teams to ensure that customers get the service that they need. The rapid increase of technology adoption, particularly in the areas of Cyber Security, Cloud, and Artificial Intelligence calls for sales teams with deep technical expertise and business acumen. Beyond the call for technical prowess, the most successful teams will be those who have a solid understand of human psychology, particularly when it comes to behaviors that drive purchasing. Being able to listen, read between the lines, and draw out the technical solution from a business conversation is more important than ever before. Further compounding these challenges, turnover in sales, particularly with Account Managers, is usually high. Turnover is extremely expensive, both financially and with the impact it has on the customer relationship. There are several factors that play into this, but with better team pairing and individual growth, turnover rate can be reduced.

In technical consulting it is extremely difficult to assess the productivity and effectiveness of sales teams (usually a paired Account Manager, AM, and a Systems Engineer, SE), particularly in larger businesses where they may have thousands of AMs and SEs. Today, all sales are tracked historically, generally through use of a Customer Relationship Database (CRM) like Salesforce. CRMs only show you what has happened (e.g., pipeline was booked, deals churned, quota closed). Sales leaders then use this information to make better informed decisions. Additionally or alternatively, many businesses will employ third party companies to assess a sample of their teams, then put together training programs for the organization. Unfortunately, this approach has no concept of individuality or any detailed assessment of how productive a particular A M/SE pair are together. Moreover, there are many technical challenges and difficulties associated with assessing aspects associated with video content provided for assessment.

The embodiments described herein enable scalability to assess thousands of sales teams per year in a much more cost-effective manner. M ore specifically, the system described herein provides the missing predictive analysis, providing sales leaders with the right dials to turn, to change quota outcomes before the CRM reports them. For example, embodiments of an AI Consulting Sales Analysis Platform according to the present disclosure deliver functionalities that enable Third Party Consultants to upload video recordings of a particular consulting team member and receive an assessment of their performance against a rubric.

One such embodiment includes an administrative panel or a few python notebooks. The administrative panel or python notebook is configured (e.g., have all the logic built) to create and manage companies, organizations, departments, and team with a hierarchical relationship. Additionally, the system is configured to enable uploading, management, and deletion of individual recordings (e.g., video recording of a sales pitch), such as those tied to the subject of the video. The video files can be assigned an identifier from being stored in the database and that identifier (‘uuid’) can be utilized as the filename. The uploaded recording can also be linked to a company, organization, team, and/or the name of the subject. The linking can include live fields that auto-populate from the database or drop-downs, or the information can be input directly from this form. The linking can also include a “paired with” field, to tie a subject to their counterpart (e.g., John Smith, AM paired with Jane Doe, SE).

These uploaded videos are then analyzed by the system according to any of the embodiments disclosed herein. For example, the audio can be split and both copies can be stored in object storage. Additionally, all audio, video, and analysis information can be stored in the database and tied back to the subject in the video. After splitting the audio and video, the system processes the audio to generate text, such as through speech to text, and the results are stored in the database with pointers to the audio and video files. The audio file and the processed text of the audio are then analyzed by the system for characteristics defined in a rubric.

The system can include multiple different rubrics for analyzing the video. For example, the administrative panel or python notebook allows for company, organization, team and job role level default rubric selection. The rubrics can be processed in any suitable manner as desired (e.g., some pieces of the rubric can be processed while others are not) and the portion of the rubric to grade against can be selected from selection fields (e.g., when uploading/linking the video). The analysis generates calculated scores from each part of the rubric and stores them in the database, tied to the original recording and the subject. The data can be stored in a hierarchical structure within the database, with grading of each part of the rubric stored for that recording tied to subject. Having job role dependent grading enables different grading of AM s and SEs on different pieces of the rubric.

Following processing, the calculated scores can be reported in any suitable manner. For example, the system can create J SON output for a company to be processed by an outside script to create reports. The system also provides the ability to review data across all organizations that exist inside of the platform and/or create batched PDF reports of the teams that have been assessed. Additionally, the system can be integrated with CRM, enabling correlation of sales teams training, enablement, and day-to-day with quota attainment, deal margin, deal cycle, etc.

The system can be secured based upon the type of platform. For example, the administrative panel can be secured with integrated authentication, while the python notebooks can provide the ability to create and delete API keys in a simple way. Those API Keys can be used to connect to the API from the Python Notebook over HTTPS. The API can be configured such that all communication between the web front-end (or Notebooks), application, and database is done through a common, secure API. Additionally or alternatively, each piece of the rubric can be broken out into separate API calls, enabling administrators or others to create a customized assessment plan based on companies, organizations, departments, teams, or job role.

The system described herein provides many advantages as compared to existing systems and methods. Through role capacity scoring, the system enables scoring of individuals' holistic knowledge and skill set as required for success in their role. This includes identifying non-obvious knowledge/skill strengths that drive quota results (e.g., people with a healthcare background close 8% more quota), identify high and low water marks for role success, and/or providing teaming recommendations to eliminate individual weaknesses through intelligent team pairing. This data can be further contextualized to make broader determinations (e.g., sellers with a score of x or above always hit their quota or sales engineers with a score of y or above double the quota of any A M they pair with).

The system described herein also provides an automated presentation and demonstration grader. This automated analysis, scoring, and detailed feedback eliminates peer and management time providing initial feedback on sales and technical presentations and demos and/or provides real-time feedback for self-improvement. Additionally, the automated presentation and demonstration grader facilitates quantifying the effect of better presentations and demos on quota attainment, identifying correlation between presenters and quota, and/or analyzing time requirements for coming up to speed on a product.

The system can further include an AI assistant rooted in a source of truth knowledge base designed to provide adaptive training support individualized to a user. This can include automatically generating study outlines, providing on-demand questions/answers, and/or delivering iterative and adaptive knowledge testing. Such data enables illustration of the correlation (if any) between fast learners and quota, identification of red flags for team members who need additional support, and/or correlation of test scoring with quota attainment.

Together, the various advantages of the system described herein enable determination of where to apply training and enablement budget to achieve revenue results (and quantify the ROI); understanding of the correlation between team knowledge, and access to knowledge, with revenue attainment; and/or receiving of recommendations for tactical changes that will change quota attainment before the books close, and the CRM reports history.

### EQUIVALENTS

Although preferred embodiments of the invention have been described using specific terms, such description is for illustrative purposes only, and it is to be understood that changes and variations may be made without departing from the spirit or scope of the following claims.

What is claimed is:

1. A system for providing a database engine, the system comprising:
a data ingestion layer;
a data processing and enrichment layer; and
a knowledge serving layer;
wherein the system is configured to provide an automated source of truth.

2. The system of claim 1, wherein the system is configured to:
ingest and filter data from one or more data sources; and
automatically validate, catalogue, index, tag, assign a confidence score along with document links, or a combination thereof.

3. The system of claim 2, wherein the data includes unstructured data.

4. The system of claim 2, wherein the data ingestion layer comprises:
at least one connector coupling the system to the one or more data sources; and
a data repository.

5. The system of claim 2, wherein the data processing and enrichment layer comprises at least one of:
a de-duplication engine;
a conflict resolution module;
a trustworthiness scoring module; and
a tagging and indexing service.

6. The system of claim 5, wherein the de-duplication engine comprises a machine-learning algorithm.

7. The system of claim 6, wherein the machine-learning algorithm is configured to de-duplicate the data at a factoid level.

8. The system of claim 6, wherein the de-duplication engine is configured to combine the machine-learning algorithm with at least one other de-duplication approach.

9. The system of claim 5, wherein the conflict resolution module is configured to assess conflicting information and determine a most likely truth.

10. The system of claim 9, wherein the conflict resolution module comprises a machine learning algorithm.

11. The system of claim 10, wherein the machine learning algorithm is trained to determine the most likely truth through at least one of analyzing source credibility, analyzing source recency, and corroborating across multiple sources.

12. The system of claim 9, wherein the trustworthiness scoring module is configured to assign a confidence score to the most likely truth.

13. The system of claim 12, wherein the confidence score id based upon at least one of source reliability, data age, level of agreement across sources, and/or the outcome of the conflict resolution process.

14. The system of claim 5, wherein the tagging and indexing service is configured to automatically extract metadata from the data.

15. The system of claim 14, wherein the tagging and indexing service extracts the metadata using natural language processing.

16. The system of claim 2, wherein the knowledge serving layer comprises a search application programming interface (API), the API configured to provide an interface for querying indexed data from the data processing and enrichment layer.

17. The system of claim 16, wherein the search API is configured to provide search results with at least one of an identified ‘truth,’ a confidence score, and a link to original source artifacts in the data.

18. The system of claim 16, wherein the knowledge serving layer further comprises a training interface configured to enable review of low-confidence data.
